(19) United States
(12) Patent Application Publication
(10) Pub. No.: US 2015/0218853 A1
(43) Pub. Date: Aug. 6, 2015

(54) LOCK RELEASE APPARATUS

(71) Applicant: TOYOTA MOTOR ENGINEERING & MANUFACTURING NORTH AMERICA, INC., ERLANGER, KY (US)

(72) Inventor: Christopher Michael Higgins, Ypsilanti, MI (US)

(73) Assignee: TOYOTA MOTOR ENGINEERING & MANUFACTURING NORTH AMERICA, INC., ERLANGER, KY (US)

(21) Appl. No.: 14/170,589

(22) Filed: Feb. 1, 2014

(51) Int. Cl. E05B 85/10; E05B 83/18; E05B 79/20

(52) U.S. Cl. CPC E05B 85/10; E05B 79/20; E05B 83/18

(57) ABSTRACT

A lock release apparatus has a handle and a cable. The handle has a gripping portion and a cable receiving portion. The cable, which is capable of a path of movement over the cable receiving portion, has a cable end which is retained within the handle through an opening of the cable receiving portion. The cable receiving portion includes at least one retention portion which is deflectable in response to compressive force and a blocking portion that blocks engagement of the cable with the at least one retention portion. In another aspect, the cable receiving portion includes at least one retention portion, without a blocking portion, where the at least one retention portion is located out of the path of movement of the cable with respect to the handle.

### BACKGROUND

This disclosure relates generally to a lock release apparatus and, more particularly, to a handle of a vehicle lock release apparatus which allows the trunk to be opened from inside.

Current trunk lock apparatus includes a handle and a cable located inside the trunk, wherein one end of the cable is attached to a release mechanism within a trunk lock and the other end of the cable is attached to the handle. When the handle is pulled, tension in the cable is generated which actuates the releases mechanism in the trunk lock, thus opening the trunk from inside.

Current lock release designs employ a low cost, one-piece assembly or a more expensive, two-piece assembly. The one-piece lock release assemblies do not provide the degree of robustness required by current motor vehicles.

It would be desirable to provide robust handle that retains the other end of the cable in the handle while still allowing easy insertion during assembly.

### SUMMARY

The present lock release apparatus is intended to provide a robust handle for a lock release apparatus while having a low cost, one-piece construction and ease of assembly.

According to a first aspect, a lock release apparatus has a handle and a cable. The handle has a gripping portion and a cable receiving portion. The cable, which is capable of a path of rotation movement over the cable receiving portion, has a cable end which is retained within the handle. The cable receiving portion includes at least one retention portion which is deflectable in response to compressive force, and a blocking portion blocking engagement of the cable with the at least one retention portion.

The cable receiving portion includes an aperture at an end for receiving the cable. The blocking portion is aligned with the aperture in the path of movement of the cable.

The cable receiving portion also includes a handle end portion for supporting the cable end in the handle. The cable receiving portion is formed such that a first distance between an inner surface of the handle end portion and an end of the blocking portion is longer than a second distance between the inner surface of the handle end portion and the end of the at least one retention portion.

The at least one retention portion can include a pair of retention portions with the blocking portion disposed between the pair of retention portions.

The blocking portion is positioned for blocking the cable when the cable rotates in respect to the handle.

According to second aspect of the lock release apparatus, a handle has a gripping portion and a cable receiving portion including an opening. The cable receiving portion has at least one retention portion which is deflectable in response to compressive force. A blocking portion formed in the cable receiving portion blocks engagement of the cable with the at least one retention portion.

The cable receiving portion includes an aperture at an end of the cable receiving portion for receiving the cable end. The blocking portion is aligned with the aperture in the path of rotation movement of the cable.

The cable receiving portion also includes a handle end portion for supporting the cable end in the handle. The handle end portion is formed such that a first distance between an inner surface of the handle end portion and the end of the blocking portion is longer than a second distance between the inner surface of the handle end portion and the end of the at least one retention portion. The at least one retention portion can be angled downward relative to the blocking portion.

The at least one retention portion can include a pair of retention portions in this aspect. The blocking portion is disposed between the pair of retention portions.

According to third aspect of the lock release apparatus, the lock release apparatus has latchable elements which are carried on a closure panel of a vehicle for releasibly latching the closure panel in a closed position on the vehicle. The lock release apparatus has a handle and a cable located inside of the closure or trunk. The handle has a gripping portion and a cable receiving portion including an opening. The cable has a cable end, wherein an opposite end of the cable is adapted to be attached to a release mechanism in a vehicle luggage compartment and the cable end is attached to the cable-receiving portion of the handle. The cable-receiving portion can have one or at least two retention portions, which are deflectable in response to compressive force, and a blocking portion disposed between the one or at least two retention portions for blocking the engagement of the cable with the retention portions when the cable rotates in respect to the handle.

In another aspect, a lock release apparatus has a handle and a cable. The handle has a gripping portion and a cable-receiving portion. The cable, which is capable of a path of rotation movement over the cable-receiving portion, has a cable end which is retained within the cable-receiving portion of the handle. The cable-receiving portion includes at least one retention portion or member which is deflectable in response to compressive force allowing insertion of the cable end into the cable-receiving portion. The at least one retention portion is disposed out of the path of movement of the cable so as not to interfere with movement of the cable or be moved by contact with the cable to a position which may allow separation of the cable end from the cable-receiving portion of the handle.

Other applications of the present invention will become apparent to those skilled in the art when the following description of the contemplated for practicing the invention is read in conjunction with the accompanying drawings.

### BRIEF DESCRIPTION OF THE DRAWINGS

FIG. 1A is a perspective view of one aspect of an interior trunk release apparatus;

FIG. 1B is a perspective view of the aspect of an interior trunk release apparatus shown in FIG. 1A where the blocking portion blocks the cable when the cable rotates with respect to the handle.

FIG. 2 is a plan view of the handle shown in FIG. 1A;

FIG. 3 is a bottom view of the handle shown in FIG. 1A;

FIG. 4A is cross section view generally along line 4A-4A of FIG. 1A in which the cable is disposed in a normal position;

FIG. 4B is cross section view generally along line 4B-4B of FIG. 1B which shows the intersection of the cable and the blocking portion for blocking the cable when the cable rotates with respect to the handle as seen in FIG. 1B;

FIG. 5 is a perspective view of another aspect of an interior trunk release apparatus, similar to the interior trunk release apparatus shown in FIG. 1 but containing modifications; and

FIG. 6 is a plan view of the handle shown in FIG. 5.

### DETAILED DESCRIPTION

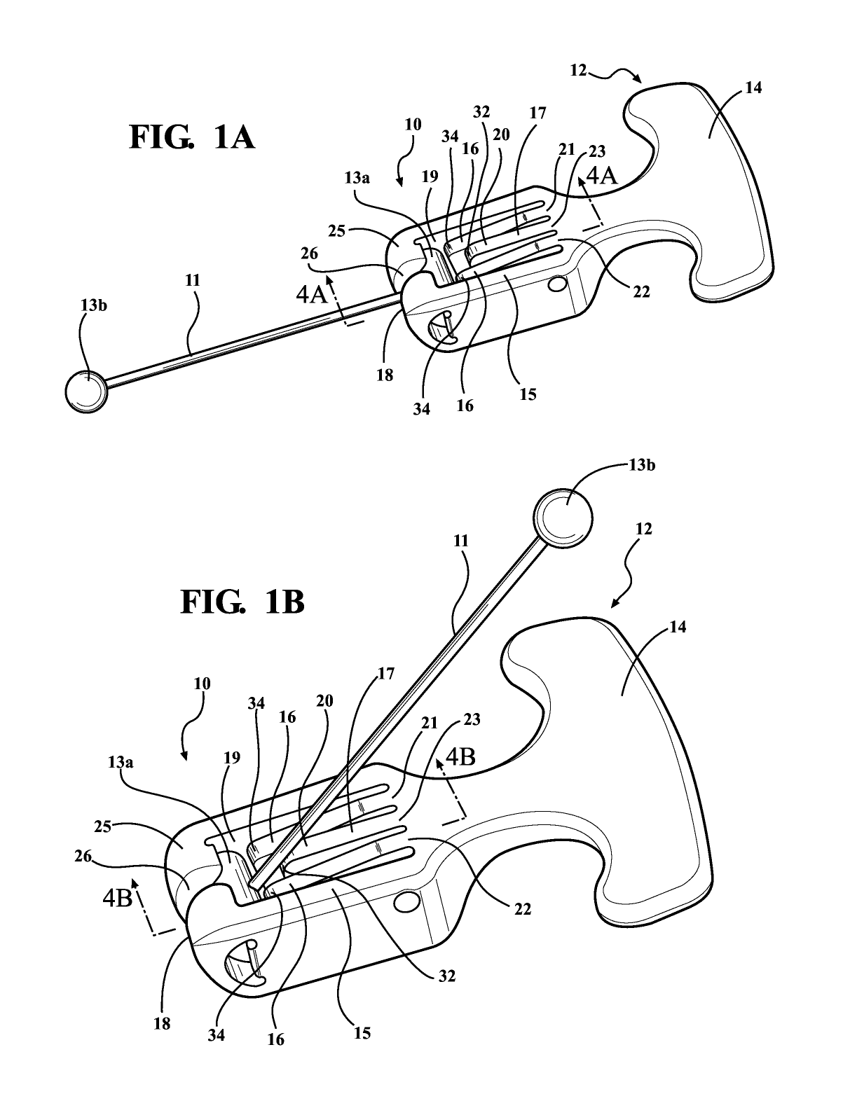

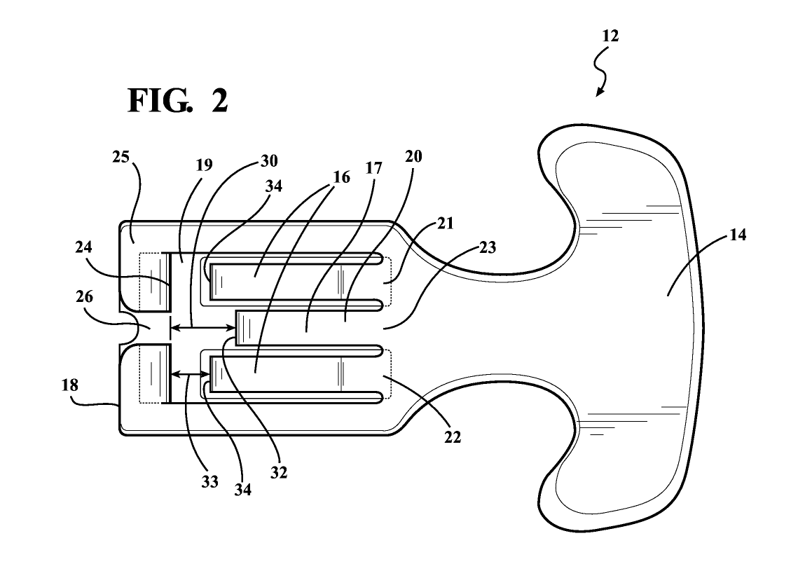

Referring to FIGS. 1A, 1B and 2, a lock release apparatus 10 has a cable 11 and a handle 12. The cable 11 has a cable right end 13a and a cable left end 13b in the orientation of the cable 11 in FIGS. 1, 4A and 4B. The cable right end 13a is cylindrical end perpendicular to cable direction. The cable left end 13b is like a sphere which is attached to the latch mechanism (not shown). The handle 12 has a gripping portion 14 in the form of a generally T-shaped trunk release handle and a cable receiving portion 15.

The cable receiving portion 15 has at least one or, as shown by example, a pair of retention portions 16, a blocking portion 17 and a handle end portion 18. The cable receiving portion 15 also has an opening 19 near the handle end portion 18 and the cable right end 13a of the cable 11 can be inserted into the opening 19. The retention portions 16 are elastically deflectable in response to compressive force and may be angled downward below an outer surface 20 of the blocking portion 17. One of the retention portions 16 extends from a first point 21 toward the opening 19 of the cable receiving portion 15. The other of retention portions 16 extends a second point 22 toward the opening 19 of the cable receiving portion 15. The first point 21 and the second point 22 may be located near end of the opening 19 at the gripping portion side.

The blocking portion 17 can be disposed between the pair of the retention portions 16 and is not elastically deflectable or movable in response to compressive force. The blocking portion 17 extends from a third point 23 which is located between the first point 21 and the second point 22 and near an end of the opening 19 at the gripping portion side toward the opening.

The handle end portion 18 is located at end of the handle 12 for supporting the cable right end 13a in the handle 12. The handle end portion 18 can include, for example, an arc-like an inner surface 24 and an outer surface 25 responding to a shape of the cable end or any other shape. The handle end portion 18 has an aperture 26 for receiving the cable 11. Once the cable right end 13a is inserted through the opening 19, the cable 11 is stored in the aperture 26. The cable 11 is rotatable with respect to the handle 12 through the aperture 26 until it contacts the blocking portion 17.

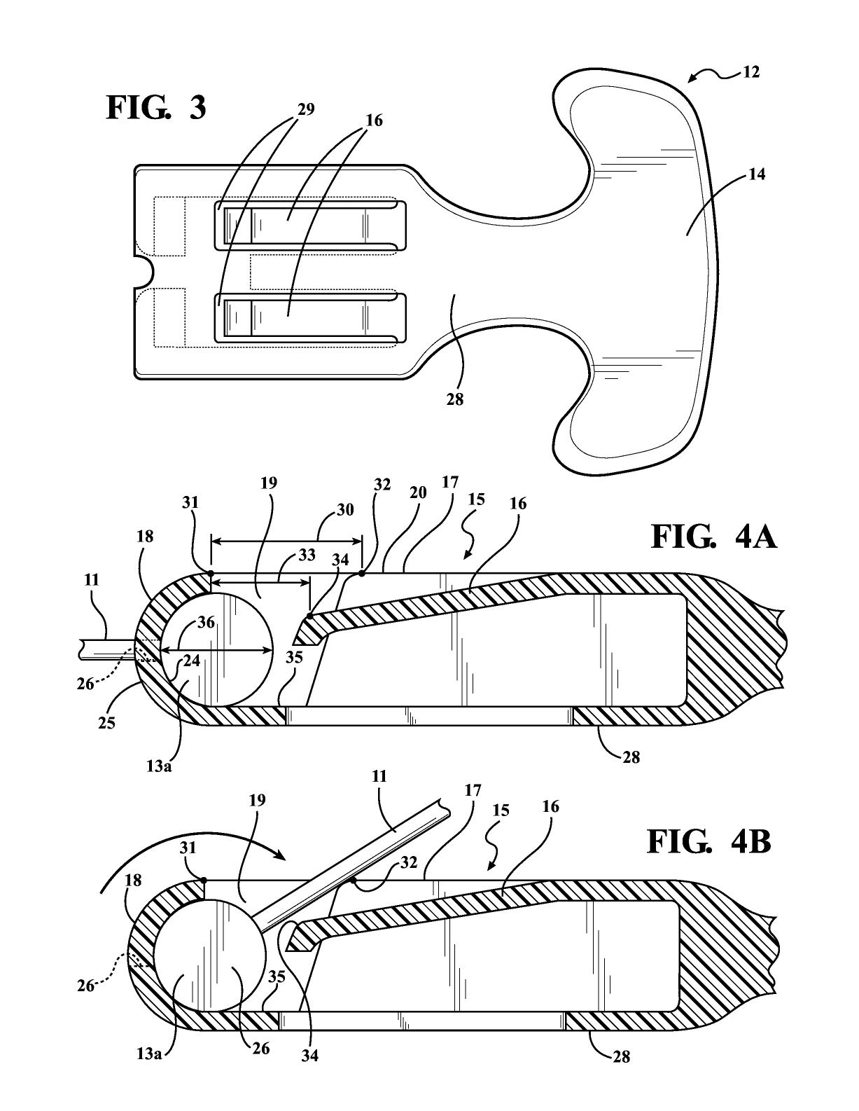

Referring to FIG. 3, a back wall 28 of the handle 12 has a pair of back apertures 29 corresponding to the pair of the retention portions 16. The back apertures 29 allow the retention portions 16 to bend without restriction through the back wall 28 of the handle 12 during insertion of the cable right end 13a.

Referring to FIG. 2, FIG. 4A and FIG. 4B, the cable receiving portion 15 is formed such that a first distance 30 between an upper edge 31 of the inner surface 24 of the handle end portion 18 and an upper edge 32 of the blocking portion 17 is longer than a second distance 33 between the upper edge 31 of the inner surface 24 of the handle end portion 18 and upper edge 34 of the end of the retention portions 16. For example, both the first and second distances 30, 33 are a horizontal distance relative to a bottom surface 35 of the cable receiving portion 15.

The cable right end 13a has a diameter 36. The cable receiving portion 15 is formed such that the diameter 36 of the cable right end 13a is smaller than the first distance 30. For this reason, the cable right end 13a can be inserted easily through the opening 19 in the cable receiving portion 15 because the cable right end 13a will not interfere with the blocking portion 17 during insertion. On the other hand, the cable receiving portion 15 is formed such that the diameter 36 of the cable right end 13a is larger than the second distance 33. For this reason, once the cable right end 13a is stored in the cable-receiving portion 15, the retention portions 16 retain the cable right end 13a in the handle 12.

The receiving portions 15 maybe formed such that a height of the upper edge of the blocking portion 17 from the bottom surface 35 of the cable receiving portion 15 is higher than that of the upper edge 34 of the retention portions 16. That is, the cable receiving portion 15 may be formed such that at least one portion of the retention portions 15 is angled below an outer surface 20 of the blocking portion 17.

Referring to FIG. 4A and FIG. 4B, the cable 11 in FIG. 4A is disposed in a normal position and cable 11 in FIG. 4B is shown interacting with the blocking portion 17. Therefore, the blocking portion 17 prevents contact of the cable 11 with and movement of the retention portion 16.

During assembly of the cable 11 to the handle 12, the retention portions 16 are bent in response to a compression force as the cable right end 13a is inserted under force to the opening 19 for insertion and the receiving portion 15 is opened up. The cable right end 13a is inserted into the opening 19 in the cable receiving portion 15 while the compression force exists. After the cable right end 13a is stored in the cable-receiving portion 15, the retention portions 16 return to the normal position due to elastic force and retain the cable right end 13a in the handle 12. In addition, once the cable right end 13a is stored in the cable-receiving portion 15, the retention portions 16 remain in a normal position since the cable 11 cannot engage and move the retention portions 16 due to the blocking portion 17 and thereby keep retaining the cable right end 13a.

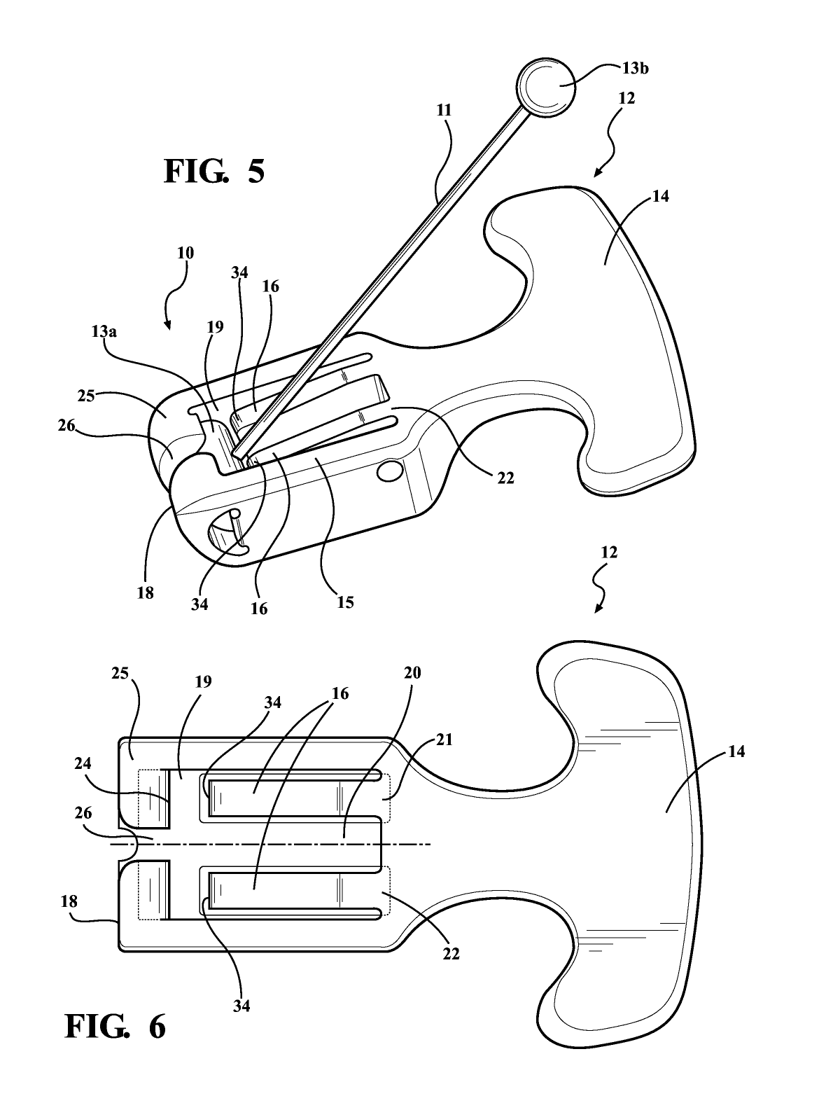

Referring now to FIGS. 5 and 6, there is depicted another aspect of the lock release apparatus in which the cable 11 and the handle 12 are substantially identical to the cable 11 and handle 12 described above and shown in FIGS. 1A-4B.

The handle 12 is a one piece handle, including the one or more retention portions 16. The one or more retention portions 16 are contained substantially within the periphery of the handle 12.

In this aspect of the lock release apparatus, the blocking portion 17 is removed. This provides an open space between the pair of retention portions 16 to provide a non-interference path of movement of the cable 11 with respect to the retention portions 16 in all positions of the cable 11, as shown in FIG. 5. This prevents the cable 11 from contacting and moving the one or more retention portions 16 which could interfere with the function of the retention portions 16 in retaining the cable right end 13a in the cable receiving portion 15 of the handle 12.

It should be noted that the right cable end 13a does not require the cable 11 to be centered between the ends of the cable right end 13a. The attachment point of the cable 11 to the cable right end 13a maybe off center of the cable right end 13a. In this instance, the single retention portion 16 or the pair of retention portions 16 are arranged within the handle 12 so as to be located out of the path of movement of the cable 11.

The lock release apparatus 10 thus provides a robust handle 12 that retains the cable right end 13a in the handle 12 while still allowing easy insertion during assembly of the cable 11 to the handle 12.

While the lock release apparatus 10 has been described in connection with what is presently considered to be the most practical, it is to be understood that the lock release apparatus 10 is not be limited to the disclosed aspects but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A lock release apparatus comprising:
a handle having a gripping portion and a cable receiving portion;
a cable having a cable end retained within the cable receiving portion;
the cable receiving portion including;
at least one deflectable retention portion; and
a blocking portion aligned with the path of rotation movement of the cable.

2. The lock release apparatus of claim 1 wherein the blocking portion is configured to block engagement of the cable with the at least one retention portion.

3. The lock release apparatus of claim 2 wherein,
the cable receiving portion includes a handle end portion supporting the cable end in the handle; and
a first distance between an inner surface of the handle end portion and an end of the blocking portion is longer than a second distance between an inner surface of the handle end portion and an end of the at least one retention portion.

4. The lock release apparatus of claim 3 wherein a diameter of the cable end is shorter than the first distance and larger than the second distance.

5. The lock release apparatus of claim 1 wherein the at least one retention portion includes a pair of retention portions.

6. The lock release apparatus of claim 5 wherein the blocking portion is disposed between the pair of retention portions.

7. The lock release apparatus of claim 1 wherein at least one portion of the at least one retention portion is angled below an outer surface of the blocking portion.

8. The lock release apparatus of claim 1 wherein the blocking portion is immovably fixed in the handle.

9. A handle for a lock release apparatus comprising:
a gripping portion;
a cable receiving portion, the cable receiving portion including;
at least one retention portion deflectable in response to compressive force; and
a blocking portion aligned with a path of movement of the cable.

10. The handle of claim 9 wherein blocking portion is configured to block engagement of the cable with the at least one retention portion.

11. The handle of claim 10 wherein the cable receiving portion includes:
a handle end portion supporting the cable end in the handle; and
a first distance between an inner surface of the handle end portion and an end of the blocking portion is longer than a second distance between an inner surface of the handle end portion and an end of the at least one retention portion.

12. The handle of claim 11 wherein the at least one retention portion includes a pair of retention portions.

13. The handle of claim 12 wherein the blocking portion is disposed between the pair of retention portions.

14. The handle of claim 9 wherein the at least one retention portion is angled below an outer surface of the blocking portion.

15. The handle of claim 9 wherein the blocking portion is immovably fixed in the handle.

16. A lock release system having latchable elements carried on a closure panel of a vehicle for releasibly latching the closure panel in a closed position on the vehicle comprising:
a handle, the handle having a gripping portion and a cable receiving portion including an opening;
a cable having an cable end retained within the cable receiving portion;
the cable receiving portion including;
at least two retention portions deflectable in response to compressive force and extending toward the opening;
a blocking portion disposed between the pair of retention portions for blocking with the engagement of the cable with the pair of retention portions when the cable rotates in respect to the handle;
the blocking portion is aligned with an aperture and the path of movement of the cable;
a first distance between an inner surface of the handle end portion and an end of the blocking portion is longer than a second distance between an inner surface of a handle end portion and an end of the at least one retention portion; and
a diameter of the cable end is smaller than the first distance and larger than the second distance.

17. A lock release apparatus comprising:
a handle having a gripping portion and a cable receiving portion;
a cable having a cable end retained within the cable receiving portion; and
the cable receiving portion including at least one cable retention portion, the at least one cable retention portion disposed within the handle out of a path of movement of the cable to prevent interference with the cable.

18. The lock release apparatus of claim 16 further comprising:
the at least one retention portion including a pair of spaced retention portions; and
both of the pair of retention portions disposed out of the path of movement of the cable with respect to the handle.

19. The lock release apparatus of claim 17 wherein,
the handle is a one piece handle.

20. The lock release apparatus of claim 17 wherein,
the at least one retention portion is contained substantially within a periphery of the handle.
